(19) United States
(12) Patent Application Publication
(10) Pub. No.: US 2003/0137135 A1
(43) Pub. Date: Jul. 24, 2003

(54) Cold Gas Generator

(75) Inventor: Siegfried Welz, Fellbach (DE)

(73) Assignee: Welz Industrieprodukte GmbH, Fellbach, 70736 (DE)

(21) Appl. No.: 10/248,210

(22) Filed: Dec. 27, 2002

Related U.S. Application Data
(63) Continuation of application No. PCT/EP01/06990, filed on Jun. 21, 2001.

(30) Foreign Application Priority Data
Jun. 29, 2000 (DE) 100 31 751.0

(51) Int. Cl. B60R 21/26

(52) U.S. Cl. 280/741

(57) ABSTRACT

### Abstract of Disclosure

A cold gas generator for an airbag system has a storage device filled with a gas under pressure. The storage device has a first end and a second end. A triggering device is provided at the first end for introducing the gas when needed into an airbag. The second end has a convexly curved bottom with a receiving opening arranged approximately centrally in the bottom. A safety valve is inserted into the receiving opening as a closure and attached by welding to the receiving opening.

### Cross Reference to Related Applications

This is a continuation of International Application PCT/EP01/06990 with an international filing date of June 21, 2001, not published in English under PCT Article 21(2), and now abandoned.

### Background of Invention

1. Field of the Invention.

The invention relates to a cold gas generator for an airbag system comprising a storage device filled with a gas under pressure, wherein one end of the storage device has a trigger mechanism for feeding the gas into an airbag, when needed, and wherein the opposed end is closed by a bottom with a safety valve.

2. Description of the Related Art.

Known cold gas generators for airbag systems have a storage device filled with a gas under pressure, wherein the gas in the case of an accident is guided by a triggering device from the storage device into a folded airbag. The airbag is inflated by the gas and serves as an impact protection for the passengers of, for example, a motor vehicle. The triggering device is actuated by a control device which generates a corresponding signal depending on the predetermined impact load. The limited space available for mounting in a motor vehicle requires a configuration of the storage device as small as possible so that for a safe filling of an airbag in an accident situation a high filling pressure of the storage device is needed. In the case of extreme heat development and, in particular, in the case of fire, the storage device can reach a gas pressure which exceeds the construction-defined limits causing an overload of the storage device.

From U.S. patent 4,275,901 a cold gas generator with an elongate, approximately cylindrical storage device is known having at one end a triggering mechanism for filling an airbag, when needed. At the opposite end, the cylindrical storage device is shaped alternatingly convexly and concavely similar to a bottle neck, wherein a thread is provided on the bottle neck. A filling valve is screwed onto the thread and subsequently welded thereto. A melting body is provided in the filling valve which melts in the case of fire and thus releases a flow channel through which the gas stored under high pressure in the storage device is supposed to be released in a controlled fashion.

For attachment of the combined filling and safety valve a complex geometric configuration of the storage device in the form of a bottle neck with a corresponding manufacturing-technological expenditure is required. The combination valve with a separate closure cap in which a flow throttle is integrated is constructively complex. Mounting requires that first a base body is screwed onto the bottle neck and, subsequently, is welded to it. Subsequently, the storage device is filled with gas and the filling channel is also welded shut. Finally, the closure cap with the integrated throttle valve is mounted.

The configuration of the safety valve as a bore filled with a melting body acts only indirectly as a safety means against possibly occurring excess pressure. A local heating of the storage device on the opposite end, for example, by means of a locally limited electrical wiring fire can result in excess pressure of the stored gas without the melting body reaching the required temperature for releasing the excess pressure (over pressure).

### Summary of Invention

It is an object of the present invention to provide a cold gas generator with reduced manufacturing expenditure and improved safety.

In accordance with the present invention, this is achieved in that the bottom is convexly shaped and approximately centrally provided with a receiving opening in which a safety valve is welded as a closure means into the receiving opening.

For this purpose, it is provided that the bottom of the storage device is convexly curved wherein a receiving opening remains approximately at the center of the bottom. This receiving opening is closed shut by a safety valve welded into the opening and acting as a closure. In this way, with simple manufacturing-technological means the storage device can be manufactured as a semi-finished product from tubular material wherein the bottom of the storage device is convexly inwardly curved in a deformation or shaping process. The tool expenditure for this shaping process is minimal.

As a result of the centrally arranged opening the storage device can be filled with gas and subsequently closed by a cover welded to it. The welding of the cover in the receiving opening significantly reduces the constructive length of the storage device and thus of the entire cold gas generator. By filling the storage device through the receiving opening, the closure must be embodied only as a safety valve without providing a filling function; this enables a simple configuration. The safety valve preferably is a pressure relief valve which increases the operational safety because the pressure relief valve releases the compressed gas above a defined limit pressure independent of the cause of the pressure rise. This safely prevents overloading of the storage device.

In a preferred configuration the pressure relief valve comprises a pressure relief opening and a bursting disk which seals and covers the pressure relief opening. This disk is sized such that it withstands the constructively defined gas pressure but will burst upon surpassing a defined limit pressure so that the gas can be released in a controlled fashion via the pressure relief opening. This configuration enables the precise adjustment of a defined limit pressure with minimal constructive and manufacturing technological expenditure. The bursting disk is preferably arranged at the storage device side of the pressure relief opening so that the bursting disk, as a result of the gas pressure present in the storage device, will rest against the edge of the pressure relief opening. An attachment of the bursting disk, in particular, by a circumferential gas-tight welding seam extending about the pressure relief opening, therefore must provide substantially only a sealing function while the mechanical loading is minimal.

Advantageously, in the pressure relief opening a flow throttle, in particular, on the side facing away from the bursting disk, is provided. In this way, the pressure relief opening and the bursting disk can be configured with a correspondingly large surface area which results in a precise adjustability of the limit or burst pressure. At the same time, in an over pressure situation the flow throttle prevents, particularly in the case of helium as a filling gas, a release that is too fast because of the excellent flow properties of helium in combination with the high filling pressure possible with helium. As a result of the arrangement of the flow throttle on the side facing away from the bursting disk of the pressure relief opening, the bursting disk is not impaired by the flow throttle when bursting.

Advantageously, the pressure relief opening is a cylindrical bore with a correspondingly large diameter. At the bottom of this bore, approximately coaxially thereto, a throttle bore with a matched smaller diameter is provided which forms the flow throttle. With this arrangement, the pressure relief opening together with the throttle bore can be drilled in a simple way in a single working step. The bore with the greater diameter has expediently a depth which corresponds at least approximately to half its diameter. In this way it is prevented that individual portions of the destroyed disk in the deformed state will reach the throttle bore and accidentally cover it. The rim of the pressure relief opening adjoining the bursting disk is expediently rounded so that the bursting disk upon bursting with plastic deformation can conform to the roundness. The round portion prevents an excessive deformation of the bursting disk and thus the tearing off of individual pieces so that plugging of the pressure relief opening is prevented.

The safety valve is preferably arranged in a closure plate which can be produced easily because of its areal configuration and can be welded into the receiving opening in the bottom of the storage device. The areal configuration reduces the size of the storage device overall. In this connection, the closure plate advantageously has a conically tapering mounting seat in the direction of the storage device with which the closure plate can contact the edge or rim of the receiving opening when mounting the closure plate. The conical configuration of the mounting seat simplifies the exact adjusted mounting and prevents slipping into the receiving opening to a depth that is too great. Moreover, as a result of the conical mounting seat a large surface area contact on the rim of the receiving opening is provided so that the connecting welding seam can be configured with a correspondingly large surface, ensuring a minimal load, and a gas-tight configuration.

### Brief Description of Drawings

Fig. 1 is an overview illustration of the cold gas generator with a safety valve configured as a closure welded thereto.

Fig. 2 shows in an enlarged cross-sectional illustration details of the safety valve of the cold gas generator according to Fig. 1.

### Detailed Description

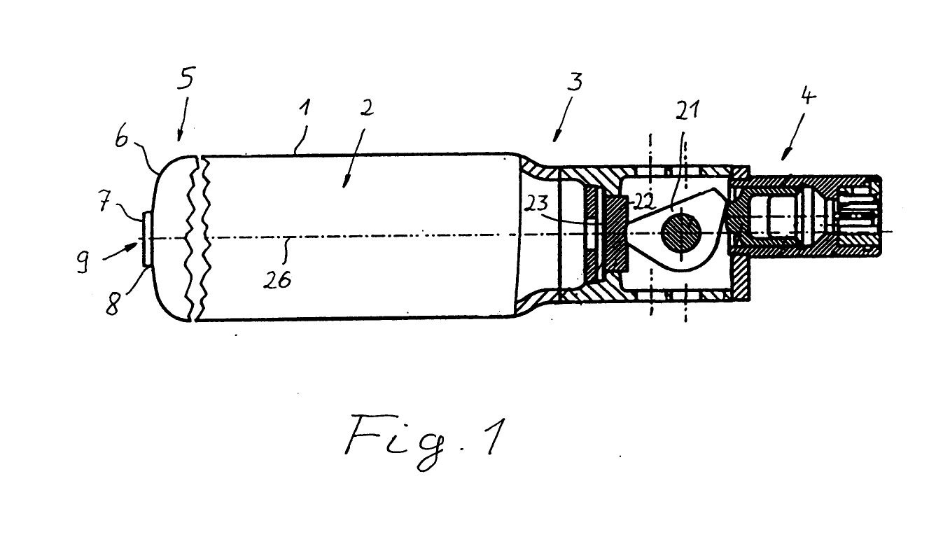

The overview illustration of Fig. 1 shows a cold gas generator for an airbag system in which a gas 2 is stored under pressure in a storage device 1. The gas is helium. At one end 3 of the storage device 1 having a substantially cylindrical configuration a triggering device 4 is provided which, when needed, acts on a support lever 21. A gas outlet opening 25 is closed by a sealing disk 23 in a gas-tight way wherein the sealing disk 23 is supported by an intermediate pressure plate 22 on the support lever 21. With an actuation of the triggering device 4 when needed, the support lever 21 is pivoted laterally wherein its support action on the pressure plate 22 and the sealing disk 23 is removed. The gas pressure acting on the sealing disk 23 bursts the sealing disk so that the gas 2 can flow into an airbag (not illustrated).

On the opposite end 5 of the storage device 1, a convexly curved bottom 6 approximately in the shape of half a rotational ellipsoid is provided. A semi-spherical or a conical configuration of the bottom 6 can also be expedient. The bottom 6 is configured as a unitary part of the storage device 1 and has a receiving opening 8 centrally arranged in the area of the longitudinal axis 26. In the receiving opening 8 a closure in the form of a safety valve 7 is attached by welding.

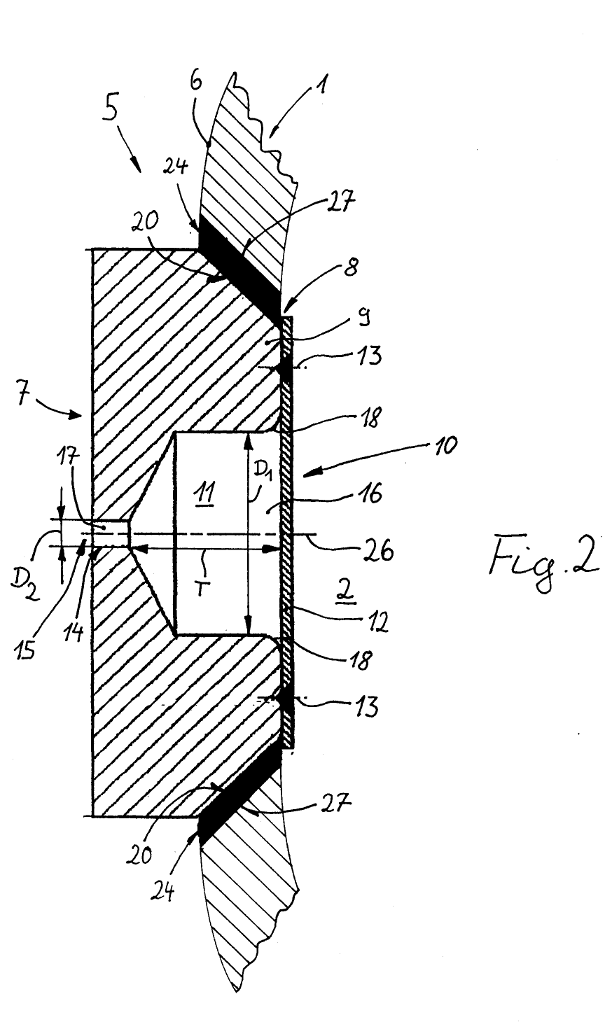

In the enlarged cross-sectional illustration of Fig. 2, details of the safety valve 7 and of the bottom 6 of a cold gas generator of Fig. 1 are illustrated. The bottom 6 of the storage device 1 has concentrically to the longitudinal axis 26 a receiving opening 8 with a conical rim 27.

The safety valve 7 configured as a pressure relief valve 10 is gas-tightly welded into the receiving opening 8 by means of a peripheral welding seam 24. The safety valve 7 forms a closure for the receiving opening 8. The safety valve 7 comprises a closure plate 9 which has a conically tapering mounting seat 20 in the direction of the storage device 1. A welding seam 24 extends areally and gas-tightly between the conical mounting seat 20 and the conical rim 27 of the receiving opening 8 provided with an approximately parallel surface.

The bore 16 which extends approximately coaxially to the longitudinal axis 26 forms a pressure relief opening 11 and is closed at the side of the stored gas 2 by a bursting disk 12. The bursting disk 12 is secured by means of a circumferential welding seam 13 on the closure plate 9. At the bottom of the bore 16, coaxially thereto, a throttle bore 17 is arranged on the side 15 of the pressure relief opening 11 facing away from the bursting disk 12. The throttle bore 17 forms a flow throttle 14 for the gas 2 exiting in the overpressure situation. The throttle bore 17 has a diameter D2 which is significantly smaller than the diameter D1 of the bore 16. The bore 16 has a depth T which is greater than half its diameter D1. The circumferential rim 18 of the bore 16 adjoining the bursting disk 12 is rounded.

While specific embodiments of the invention have been shown and described in detail to illustrate the inventive principles, it will be understood that the invention may be embodied otherwise without departing from such principles.

Claims

1. WHAT IS CLAIMED IS:
1.A cold gas generator for an airbag system, the cold gas generator comprising:
a storage device (1) filled with a gas (2) under pressure, the storage device (1) having a first end (3) and a second end (5);
a triggering device (4) for introducing the gas (2) when needed into an airbag;
wherein the second end (5) has a convexly curved bottom (6);
wherein the bottom (6) has a receiving opening (8) arranged approximately centrally in the bottom (6);
a safety valve (7) inserted as a closure into the receiving opening (8) and attached by welding to the receiving opening (8).

2. The cold gas generator according to claim 1, wherein the safety valve (7) comprises a pressure relief valve (10).

3. The cold gas generator according to claim 2, wherein the pressure relief valve (10) comprises a pressure relief opening (11) and a bursting disk (12) sealingly covering the pressure relief opening (11).

4. The cold gas generator according to claim 3, wherein the bursting disk (5) is arranged at a side of the pressure relief opening (11) facing the storage device (1) .

5. The cold gas generator according to claim 3, wherein the bursting disk (12) is secured by a gas-tight welding seam (13) peripherally about the pressure relief opening (11).

6. The cold gas generator according to claim 3, further comprising a flow throttle (14) arranged in the pressure relief opening (11).

7. The cold gas generator according to claim 6, wherein the flow throttle (14) is arranged at a side (15) of the pressure relief opening (11) facing away from the bursting disk (12).

8. The cold gas generator according to claim 7, wherein the pressure relief opening (11) is a cylindrical bore (16) having a first diameter (D1), wherein the cylindrical bore (16) has a bottom provided approximately coaxially to the cylindrical bore (16) with a throttle bore (17) having a second diameter (D2) and forming the flow throttle (14), wherein the first diameter (D1) is greater than the second diameter (D2).

9. The cold gas generator according to claim 8, wherein a depth (T) of the cylindrical bore (16) matches at least approximately half the first diameter (D1).

10. The cold gas generator according to claim 3, wherein a rim (18) of the pressure relief opening (11) adjoining the bursting disk (12) is rounded.

11. The cold gas generator according to claim 2, wherein the safety valve (7) further comprises a closure plate (9), wherein the pressure relief valve (10) is arranged in the closure plate (9).

12. The cold gas generator according to claim 11, wherein the closure plate (9) has a mounting seat (20) conically tapering in a direction toward the storage device (1).
